(19) United States
(12) Patent Application Publication
(10) Pub. No.: US 2010/0078846 A1
(43) Pub. Date: Apr. 1, 2010

(54) Particle Mitigation for Imprint Lithography

(75) Inventors: Douglas J. Resnick, Leander, TX (US); Ian Matthew McMackin, Austin, TX (US); Gerard M. Schmid, Austin, TX (US); Niyaz Khusnatdinov, Round Rock, TX (US); Ecron D. Thompson, Round Rock, TX (US); Sidlgata V. Sreenivasan, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/568,730

(22) Filed: Sep. 29, 2009

Related U.S. Application Data
(60) Provisional application No. 61/109,529, filed on Oct. 30, 2008.
(60) Provisional application No. 61/102,072, filed on Oct. 2, 2008.
(60) Provisional application No. 61/101,491, filed on Sep. 30, 2008.

(51) Int. Cl. B29C 47/76; B29C 59/02

(52) U.S. Cl. 264/101; 264/293

(57) ABSTRACT

Particles may be present on substrates and/or templates during nano-lithographic imprinting. Particles may be mitigated and/or removed using localized removal techniques and/or imprinting techniques as described.

### CROSS-REFERENCE TO RELATED APPLICATIONS

This application claims the benefit under 35 U.S.C. §119(e)(1) of U.S. Provisional Patent Application No. 61/101,491, filed on Sep. 30, 2008, U.S. Provisional Patent Application No. 61/102,072, filed on Oct. 2, 2008, and U.S. Provisional Patent Application No. 61/109,529, filed on Oct. 30, 2008, all of which are hereby incorporated by reference herein.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields, while increasing the circuits per unit area formed on a substrate; therefore, nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a polymerizable layer and transferring a pattern corresponding to the relief pattern into an underlying substrate. The substrate may be coupled to a motion stage to obtain a desired positioning to facilitate the patterning process. Additionally, the substrate may be coupled to a substrate chuck. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that features and advantages of the present invention can be understood in detail, a more particular description of embodiments of the invention may be had by reference to the embodiments illustrated in the appended drawings. It is to be noted, however, that the appended drawings only illustrate typical embodiments of the invention, and are therefore not to be considered limiting of its scope, for the invention may admit to other equally effective embodiments.

FIG. 1 illustrates a simplified side view of a lithographic system.

FIG. 2 illustrates a simplified side view of the substrate illustrated in FIG. 1, having a patterned layer thereon.

FIG. 3 illustrates a side view of the lithographic system shown in FIG. 1, with a particle positioned between the mold and the substrate.

FIG. 4 illustrates a side view of a portion of the lithographic system shown in FIG. 3, having a film with an adhesive surface for removal of a particle in accordance with an embodiment of the present invention.

FIG. 5 illustrates a side view of a portion of the lithographic system shown in FIG. 3, having a resist layer for removal of a particle in accordance with an embodiment of the present invention.

FIG. 6 illustrates a side view of a portion of the lithographic system shown in FIG. 3, having a vacuum for removal of a particle in accordance with an embodiment of the present invention.

FIG. 7 illustrates a side view a portion of the lithographic system shown in FIG. 3, having a nozzle providing cryogenic cooling material for removal of a particle in accordance with an embodiment of the present invention.

FIG. 8 illustrates a side view of a portion of the lithographic system shown in FIG. 3, having an apparatus applying electrostatic force for removal of a particle in accordance with an embodiment of the present invention.

FIG. 9 illustrates a side view of a portion of the lithographic system shown in FIG. 3, having a dummy mask for imprinting with a particle on a substrate in accordance with an embodiment of the present invention.

FIG. 10 illustrates a side view of a portion of the lithographic system shown in FIG. 3, having a soft mask layer for imprinting with a particle on the substrate in accordance with an embodiment of the present invention.

FIGS. 11 and 12 illustrate side views of formation of a patterned layer having a particle positioned therein.

FIG. 13 illustrates a flow diagram of an exemplary method for template replication.

FIGS. 14-19 illustrate simplified side views of an exemplary method for formation of a replica template using master template with minimal and/or no damage by particles.

FIG. 20 illustrates a simplified side view of another exemplary method for formation of a replica template using master template with minimal and/or no damage by particles.

FIGS. 21-24 illustrate simplified side views of another exemplary method for formation of a replica template using master template with minimal and/or no damage by particles.

FIGS. 25-29 illustrate simplified side views of another exemplary method for formation of a replica template using master template with minimal and/or no damage by particles.

FIGS. 30-34 illustrate simplified side views of another exemplary method for formation of a replica template using master template with minimal and/or no damage by particles.

### DETAILED DESCRIPTION

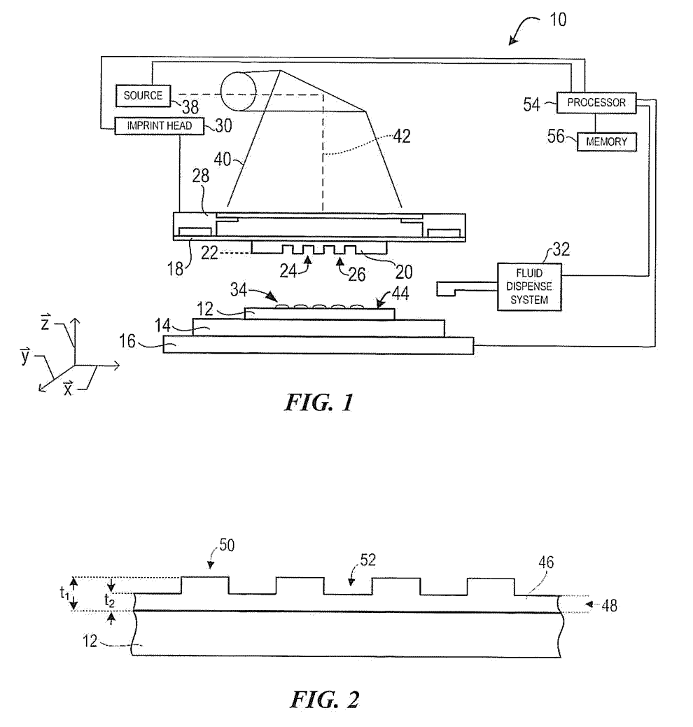

Referring to the Figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is herein incorporated by reference.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Such chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit formable material 34 (e.g., polymerizable material) on substrate 12. Formable material 34 may be positioned upon substrate 12 using techniques, such as, drop dispense, spin-coating, dip coating, chemical vapor deposition (CVD), physical vapor deposition (PVD), thin film deposition, thick film deposition, and/or the like. Formable material 34 may be disposed upon substrate 12 before and/or after a desired volume is defined between mold 22 and substrate 12 depending on design considerations. Formable material 34 may be functional nano-particles having use within the bio-domain, solar cell industry, battery industry, and/or other industries requiring a functional nano-particle. For example, formable material 34 may comprise a monomer mixture as described in U.S. Pat. No. 7,157,036 and U.S. Patent Publication No. 2005/0187339, both of which are herein incorporated by reference. Alternatively, formable material 34 may include, but is not limited to, biomaterials (e.g., PEG), solar cell materials (e.g., N-type, P-type materials), and/or the like.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by formable material 34. For example, imprint head 30 may apply a force to template 18 such that mold 20 contacts formable material 34. After the desired volume is filled with formable material 34, source 38 produces energy 40, e.g. ultraviolet radiation, causing formable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features such as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. No. 7,396,475, all of which are hereby incorporated by reference in their entirety.

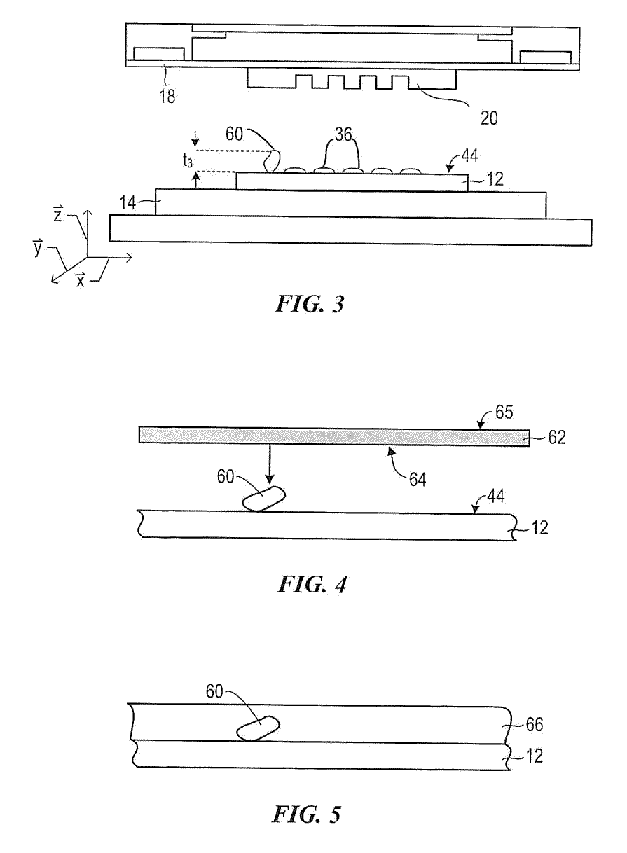

Referring to FIGS. 1-3, during the aforementioned patterning process, a particle 60 may become positioned between substrate 12 and mold 20. For example, particle 60 may be positioned upon surface 44 of substrate 12; in a further example, particle 60 may be positioned within patterned layer 46. In a further embodiment, a plurality of particles 60 may be positioned between substrate 12 and mold 20. Particle 60 may have a thickness t₃. Hereinafter, reference to particle 60 also includes reference to a plurality of particles 60.

As particle 60 may have a deleterious and/or other adverse effect during patterning of substrate 12, systems and methods addressing mitigation and/or elimination of particle 60 are herein described. Particle 60, herein, may be interchangeable with contaminant 60.

Referring to FIGS. 4-8, localized energy and/or efforts may be used to mitigate and/or remove particle 60 from substrate 12 and/or patterned layer 46. It should be noted that any of the described methods for localized removal of particle 60 may be combined and/or combined with other techniques discussed herein to further enhance mitigation and/or removal of particle 60 (e.g., imprint patterning removal, replica formation).

Referring to FIGS. 2, 3 and 4, localized removal of particle 60 may include removing particle 60 and/or a portion of particle 60 with a film 62. Film may have a first side 64 and a second side 65. First side 64 and/or second side 65 may include one or more adhesive materials. For example, first side 64 of film 62 may include an adhesive material. Adhesive material in first side 64 of film 62 may be, for example, tape, sticky film, and/or any other material capable of adhering to at least a portion of particle 60.

First side 64 of film 62 having the adhesive material may be positioned facing surface 44 of substrate 12. The size of film 62 may be the length of substrate 12, and/or proportional to the size of particle 60. For example, the size of film 62 may be limited to a few nanometers larger than the size of the particle 60. First side 64 of film 62 may be placed in contact with particle 60. Adhesive material on first side 64 of film may attach particle 60 to film 62. Upon removal of film 62, particle 60 may also be removed from substrate 12 and/or patterned layer 46. Van der Waals forces between particle 60 and film 62 may also be used in lieu of or in addition to adhesive surface 64 of film 62 for removal and/or mitigation of particle 60 from substrate 12 and/or patterned layer 46.

Referring to FIGS. 2, 3 and 5, localized removal of particle 60 may include removal of a resist layer 66 positioned on substrate 12 and substantially encapsulating particle 60. Resist layer 66 may be applied to substrate 12 by processes including, but not limited to, drop dispense, spin-coating, dip coating, chemical vapor deposition (CVD), physical vapor deposition (PVD), thin film deposition, thick film deposition, and/or the like. In one example, resist layer 66 may be drop dispensed on substrate 12 and solidified as described in relation to FIGS. 1 and 2.

Resist layer 66 may attach and/or substantially immerse a substantial portion of particle 60. Resist layer 66 may then be removed and upon removal of resist 66, particle 60 or a substantial portion of particle 60 may be removed from substrate 12 and/or patterned layer 46.

In another example, resist layer 66 may be positioned adjacent to particle 60 on substrate 12 by processes including, but not limited to, drop dispense, spin-coating, dip coating, chemical vapor deposition (CVD), physical vapor deposition (PVD), thin film deposition, thick film deposition, and/or the like. Resist layer 66 may then be patterned using a non-patterned template 18 with systems and methods described in relation to FIGS. 1 and 2. Resist layer 66 may attach and/or substantially immerse a portion of particle 60. Resist layer 66 may then be removed, and upon removal of resist layer 66, particle 60 may be removed from substrate 12 and/or patterned layer 46.

Referring to FIGS. 1-3 and 6, localized removal of particle 60 may include subjecting particle 60 to suction force 70 applied by vacuum 68. Vacuum 68 may be applied during various stages of the patterning process. Suction force 70 may provide for a predetermined magnitude of force that allows for removal of particle 60 without substantial damage to substrate 12. Control of vacuum and/or force may be under control of algorithms in programs stored in memory 56 and run in processor 54.

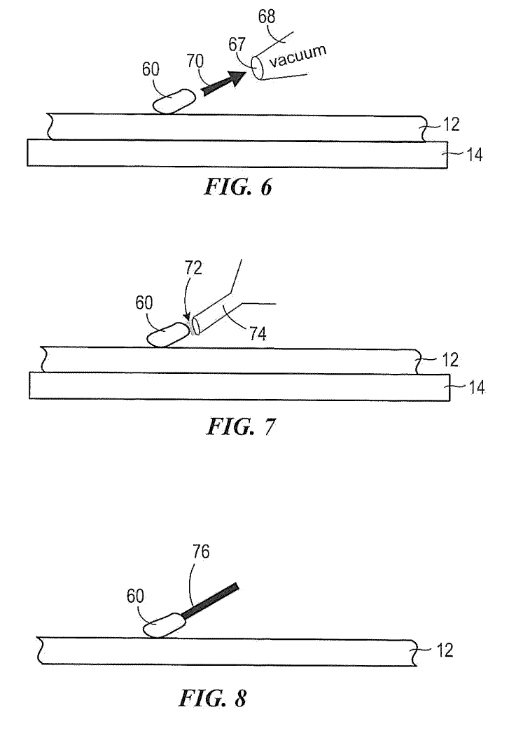

FIG. 6 illustrates positioning of one of more nozzles 67 of vacuum 68 adjacent to particle 60. Nozzles 67 may be positioned adjacent to particle 60 and/or positioned around periphery of chuck 14. For simplicity, FIG. 6 illustrates a single nozzle 67; however, embodiment of the present invention may implement any number of nozzles 67. Further, other means for transporting force 70 to particle 60 may be used to achieve a similar function

Referring to FIGS. 1-3 and 7, localized removal of particle 60 may include applying cryogenically cooled material 72 through nozzle 74 to particle 60 such that particle 60 becomes dislodged from substrate 12 and/or fragments. Particle 60 may then be removed from substrate 12 by a vacuum force (as described in FIG. 6) and/or by applying a blowing force (e.g., driving a current of air on, in, or through). In one example, cryogenically cooled material 72 may be in a liquid state and/or solid state during application to particle 60. As the cryogenically cooled material 72 warms, it may undergo a phase transition to a substantially gaseous state and diffuse away from substrate 12 carrying away particle 60 in the process.

Referring to FIGS. 1-3, and 8, localized removal of particle 60 may include applying electrostatic forces (attractive or repulsive) and/or an electronic arc directed at particle 60 by an apparatus 76. Application of electrostatic forces and/or the electronic arc may dislodge particle 60 from substrate 12 and/or fragment particle 60. Particle 60 may then be removed from substrate 12 and/or patterned layer 46 by a vacuum force (as described in FIG. 6) and/or by applying a blowing force (e.g., driving a current of air on, in, or through).

In one example, attractive electrostatic forces may be used to remove particle 60. Particle 60 may have a charge with apparatus 76 having and/or creating an opposing charge resulting in an attractive electrostatic force between particle 60 and apparatus 76. Particle 60 may then attach to apparatus 76 and be removed from substrate 12. In another example, repulsive electrostatic forces may be used to dislodge and/or drive particle 60 from substrate 12. Particle 60 may have a charge with apparatus 76 having and/or creating an opposing charge resulting in a repulsive electrostatic force between particle 60 and apparatus 76. Application of the repulsive electrostatic force may drive and/or dislodge particle 60 from substrate 12.

Imprinting processes (e.g., nano-imprint lithography) may also be used to mitigate and/or remove particle 60 from substrate 12 and/or patterned layer 46. It should be noted that any of the described methods of imprinting to mitigate and/or remove particle 60 may be combined with other methods and techniques discussed herein to further enhance mitigation and/or removal of particle 60.

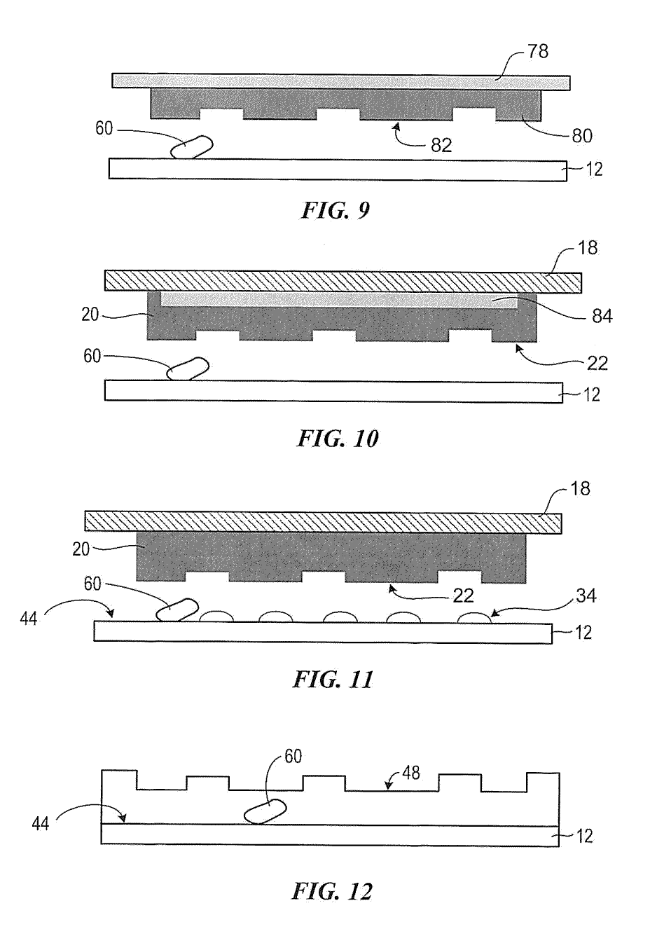

Referring to FIG. 9, methods of imprinting with particle 60 may include replacing template 18 (shown in FIG. 1) with dummy template 78 for imprinting area of substrate 12 (e.g., field) having particle 60. Referring to FIGS. 1 and 9, dummy template 78 may be a low resolution, low cost template having substantially similar pattern density to template 18. For example, dummy template 78 may include a mesa 80 extending therefrom towards substrate 12. Similar to mesa 20, mesa 80 includes a patterning surface 82 thereon. Patterning surface 82 of dummy template 78 may be substantially similar to patterning surface 22 of template 18; however, patterning surface 22 of dummy template 78 may be low-resolution and thus unyielding. As a result, damage to dummy template 78 by particle 60 may be generally inconsequential, as mesa 80 may not be intended to yield. As such, if particle 60 is identified on substrate 12 during patterning as described in relation to FIGS. 1 and 2, template 18 may be removed from system 10 and replaced with dummy template 78 to imprint in area of substrate 12 having particle to protect template 18 from damage.

Referring to FIG. 10, template 18 may be modified to incorporate a soft mask layer 84. Soft mask layer 84 may be formed of materials capable of conforming around particle 60 and thereby reducing the size of exclusion zones. Mask 20 may be formed of soft mask layer 84 and/or a separate mask layer 84 may be positioned adjacent to soft mask layer 84. For example, soft mask layer 84 may be positioned between mask 20 and surface of template 18 facing substrate 12. Patterns for imprinting as described in relation to FIGS. 1 and 2 may be created either in soft mask layer 84 and/or on patterning surface 22 of mesa 20. Alternatively, soft mask layer 84 may be positioned on mask 20 and provide pattern for imprinting substrate 12 yielding predetermined optimal results known within the industry. Soft mask layer 84 may be formed of materials including, but not limited to, polymers, spin-on glasses, and the like. For example, soft mask layer 84 may be formed of silicon containing polymers.

FIGS. 11 and 12 illustrate another exemplary imprinting technique for minimizing and/or eliminating particle damage. Generally, residual layer 48 may not include protrusions 50 and/or recessions 52 or protrusions 60 and/or recession 52 may be unviable, and as such, field of substrate 12 having particle may be unyielding. Although field of substrate 12 having particle 60 may be unyielding, adjacent fields may be minimally impacted.

Referring to FIG. 11, formable material 34 may be applied to field of substrate 12 having particle 60 positioned thereon. Formable material 34 may be solidified conforming to shape of particle 60 and/or surface 44 of substrate for mitigation of particle 60 from substrate 12 and/or patterned layer 46. Although field of substrate 12 having particle 60 may be unyielding, adjacent fields may be minimally impacted.

Formable material 34 may be positioned upon substrate 12 in area of substrate 12 having particle 60 positioned thereon using techniques described in relation to FIGS. 1 and 2. For example, formable material 34 may be positioned using techniques, such as, drop dispense, spin-coating, dip coating, chemical vapor deposition (CVD), physical vapor deposition (PVD), thin film deposition, thick film deposition, and/or the like. Template 18 may be used to spread formable material 34 across surface 44 of substrate 12. For example, template 18 may be substantially planar and using capillary action formable material 34 positioned between template 18 and substrate 12 may flow across surface 44 of substrate 12. Alternatively, formable material 34 may be positioned on surface 44 of substrate 12 without use of template 18.

Referring to FIGS. 1, 11 and 12, source 38 may provide energy 40, e.g., ultraviolet radiation, causing formable material 34 to solidify and/or cross-link conforming to shape of the surface 44 of substrate 12, and further defining residual layer 48 containing particle 60. As the residual layer 48 may not include protrusions 50 and/or recessions 52 or protrusions 60 and/or recession 52 may be unviable, field of substrate 12 having particle may be unyielding. Although field of substrate 12 having particle 60 may be unyielding, adjacent fields may be minimally impacted.

During patterning, as described in relation to FIGS. 1 and 2, contact of particle 60 to template 18 may create damage to template 18 and/or damage to features 50 and/or 52 of patterned layer 46. For example, contact of template 18 with particle 60 may cause damage to critical dimension of features 50 and/or 52 of patterned layer 46 and/or features 24 and 26 of template 18.

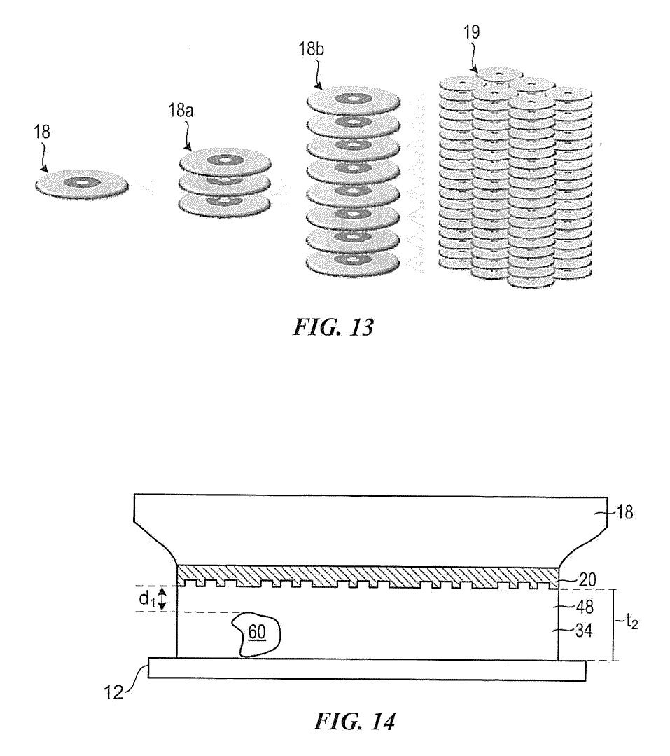

As template 18 may be expensive to manufacture, replications of template 18 (i.e., replica template 18a) may aid in reducing manufacturing costs. FIG. 13 illustrates a flow diagram for supplying such replica templates 18a for the production of multiple patterned substrates 19. Generally, template 18 (i.e., master template) may be replicated to form a plurality of replica templates 18a. Replica templates 18a may optionally form working templates 18b. Working templates 18b may be used to form patterned substrates 19. Patterned substrates 19 may be used within hard disk drive industry (shown in FIG. 13), semiconductor industry, solar cell industry, biomedical industry, optoelectronic industry, or any industry using functional materials (e.g., formable material 34). For example, working templates 18b illustrated in FIG. 13 may be used to form approximately 100,000,000 patterned substrates 19 using process and methods as described in relation to FIGS. 1 and 2, and even further employing up to 200,000,000 lithography steps for double-sided patterning of substrates 19 using process and methods, including, not limited to those described in U.S. Ser. No. 11/565,350 and U.S. Ser. No. 11/565,082, both of which are hereby incorporated by reference in their entirety.

FIGS. 14-20 illustrate simplified side view of an exemplary method for formation of replica template 18a using master template 18 with minimal and/or no damage by particle 60. Using this method, pattern transfer steps may be eliminated from processing reducing critical dimension uniformity issues and defectivity resulting from additional etching steps.

During replication of template 18 to form template 18a using systems and methods described in relation to FIGS. 1 and 2, thickness t₂ of patterned layer 46 may be pre-determined to substantially cover particle 60 and provide safety factor thickness d₁ protecting template 18 from damage by particle 60. Thickness t₂ of patterned layer 46 and/or deposition of formable material 34 may be under control of algorithms in programs stored in memory 56 and run in processor 54.

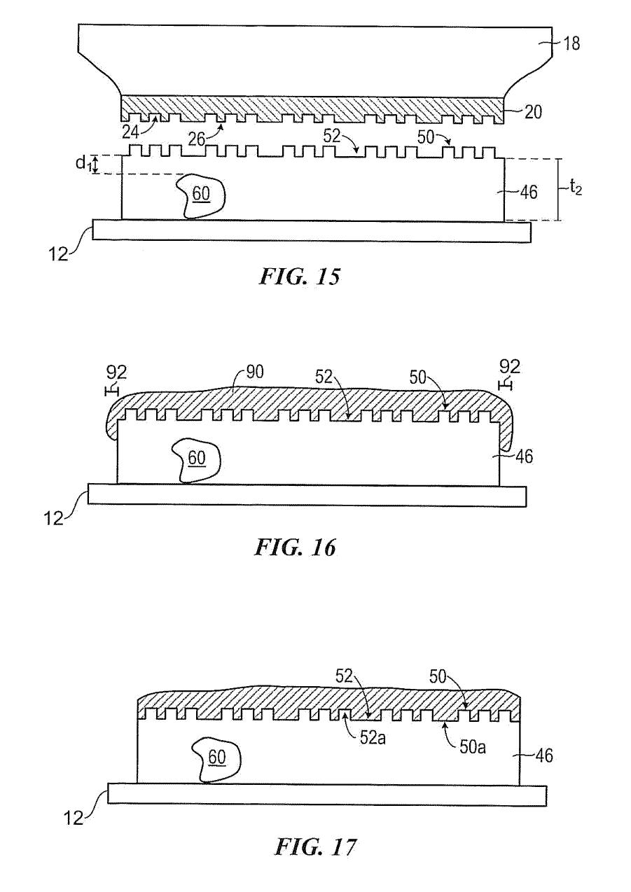

Referring to FIGS. 14 and 15, formable material 34 may be solidified and template 18 separated from patterned layer 46 having features 50 and 52. Thickness t₂ of patterned layer 46 may minimize and/or limit contact of template 18 with particle 60 during patterning process. Patterned layer 46 may include residual layer 48 having thickness t₂ determined to substantially cover particle 60 and provide safety factor thickness d₁ protecting template 18 from damage by particle 60. Safety factor thickness d₁ may be approximately 2-2000 nm. For example, safety factor thickness d₁ may be in a range of 10-200 nm.

Referring to FIGS. 16-19, a material layer 90 may optionally be positioned on patterned layer 46 to fill features 50 and 52 of patterned layer. Features 50a and 52a of material layer 90 may be formed by the filling of features 50 and 52 of patterned layer 46. A replica substrate 94 may be adhered to material layer 90 and material layer 90 separated from patterned layer 46 forming replica template 18a having features 50a and 52a.

Referring to FIG. 16, material layer 90 may be formed of materials, including, but not limited to, silicon dioxide, silicon nitride, silicon oxynitride, and/or the like. Material layer 90 may be positioned using processes including, but not limited to, drop dispense, spin-coating, dip coating, chemical vapor deposition (CVD), physical vapor deposition (PVD), thin film deposition, thick film deposition, and/or the like. For example, material layer 90 may be deposited on patterned layer 46 using CVD. The CVD process may generally provide portions of material in material layer 90 to extend in areas 92 outside of patterned layer 46.

Referring to FIG. 17, material in areas 92 outside of patterned layer 46 may be removed. Removal of material in areas 92 outside of patterned layer 46 provides material layer 90 having protrusions 50a and recessions 52a corresponding to patterned features 50 and 52 of substrate 12. For example, protrusions 50a of material layer 90 correspond to patterned recessions 50 of substrate 12 and recessions 52a of material layer 90 correspond to patterned protrusions 52 of substrate 12. Additionally, a polishing step (e.g., CMP polishing) may optionally be employed to substantially planarize material layer 90.

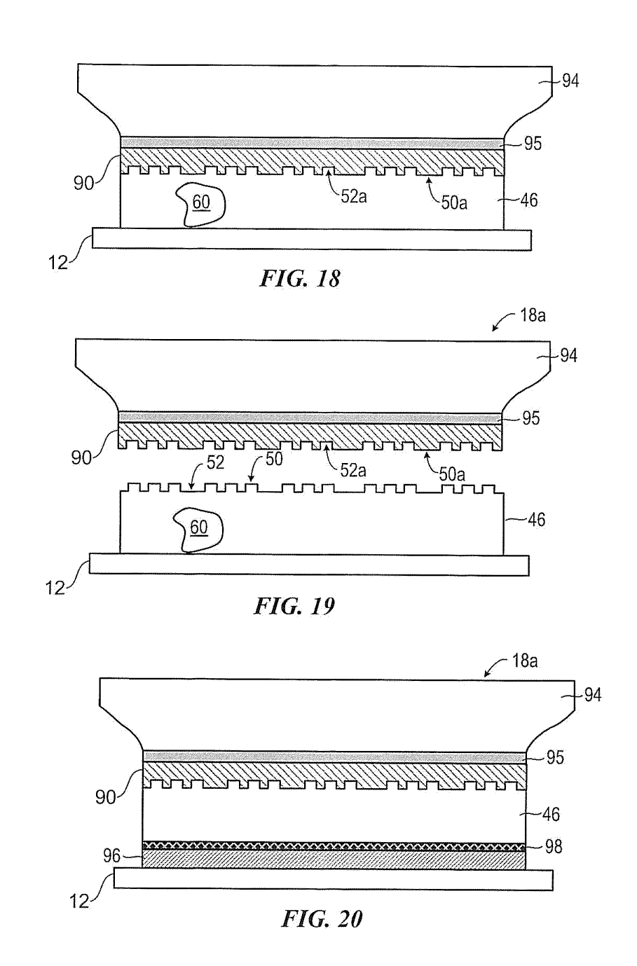

Referring to FIGS. 18-19, a replica substrate 94 may be adhered to material layer 90 to form replica template 18a using techniques and processes known within the industry. For example, an adhesion layer 95 may be deposited between material layer 90 and replica substrate 94 to form replica template 18a. Adhesion layer 95 may be formed of materials including, but not limited to, materials further described in U.S. Ser. No. 11/187,407, which is hereby incorporated by reference in its entirety herein. Alternatively, adhesion layer 95 may be formed of an oxide and/or bonded to replica substrate 94 to form replica template 18a. Bonding techniques may include, but are not limited to, thermal bonding, anodic bonding, and the like.

Replica template 18a may be separated from patterned layer 46. For example, formable material 34 forming patterned layer 46 may include selective adhesion characteristics as described in further detail in U.S. Ser. No. 09/905,718, U.S. Ser. No. 10/784,911, U.S. Ser. No. 11/560,266, U.S. Ser. No. 11/734,542, U.S. Ser. No. 12/105,704, and U.S. Ser. No. 12/364,979, which are all hereby incorporated by reference in their entirety. Generally, replica template 18a may be separated from patterned layer 46 causing minimal stress to features 50a and 52a and/or features 50 and 52. Replica template 18a may then be used to create additional working templates 18b as described in relation to FIG. 13.

Referring to FIG. 20, replica template 18a may be alternatively separated from patterned layer 46 through the use of a soluble material 96 positioned between patterned layer 46 and substrate 12. Similar to the above described method, pattern transfer steps may be eliminated from processing reducing critical dimension uniformity issues and defectivity resulting from additional etching steps. Additionally soluble material 96 positioned between patterned layer 46 and substrate 12 may be selectively etched. For example, an oxidizing cleaning process may be used to selectively etch only the organic material of soluble material 96 leaving inorganic material to form replica template 18a.

Soluble material 96 may include, but is not limited to, polymethylglutarimide (PMGI). PMGI may be stripped using tetramethylammonium hydroxide (TMAH). Additionally, an adhesion layer 98 may be positioned between soluble material 96 and patterned layer 46. Adhesion layer 98 may include, but is not limited to BT20 as described in U.S. Publication No. 2007/0021520, which is hereby incorporated by reference herein in its entirety.

To separate replica template 18a from patterned layer 46, soluble material 96 may be washed off thereby breaking connection from substrate 12. Patterned layer 46 may be formed of organic material. An oxidizing cleaning process (e.g., O₂ plasma) may be used to remove patterned layer 46, having limited silicon content and resulting in formation of replica template 18a. It should be noted that other cleaning processes may be used including, but not limited to, UV ozone, VUV, ozonated water, sulfuric acid/hydrogen peroxide (SPM), and the like.

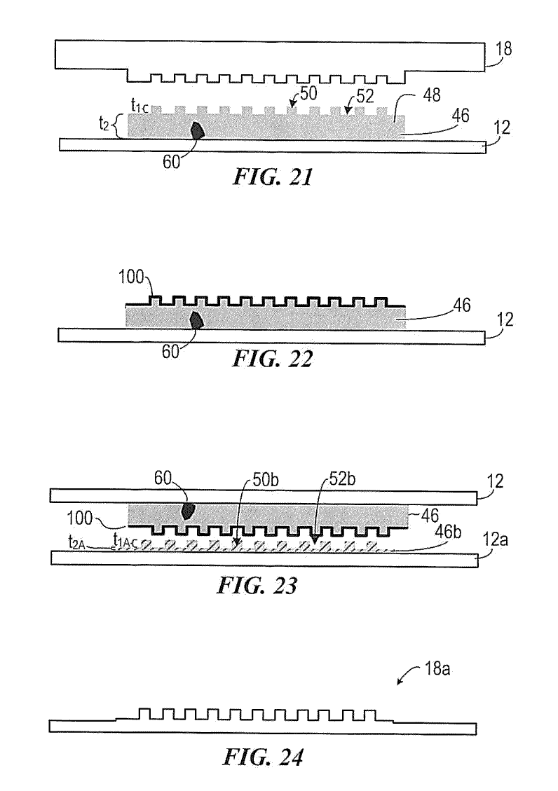

FIGS. 21-24 illustrate simplified side view of another exemplary method for formation of replica template 18a using master template 18 with minimal and/or no damage by particle 60.

Referring to FIG. 21, master template 18 may imprint patterned layer 46 on substrate 12 using systems and process described in relation to FIGS. 1 and 2. Substrate 12 may be formed of materials including, but not limited to, fused-silica, quartz, silicon, organic polymers, siloxane polymers, borosilicate glass, fluorocarbon polymers, metal, hardened sapphire, and/or the like.

Patterned layer 46 may include residual layer 48 and a plurality of features shown as protrusions 50 and recession 52. Protrusions 50 having thickness t₁ and residual layer 48 having thickness t₂. Thickness t₂ of residual layer 48 may be increased to account for particle 60. For example, thickness t₂ of residual layer 48 may be greater than approximately 150 nm such that residual layer 48 immerses particle 60.

Referring to FIG. 22, a surface treatment 100 may be applied to patterned layer 46. Surface treatment 100 may have characteristics that facilitate the spread of formable material 34 prior to solidification and/or cross-linking of formable material 34, and/or to facilitate release of materials (e.g., facilitates release characteristics of patterned layer 46). For example, surface treatment 100 may include an oxide layer created by a vapor treatment (e.g., hexamethyldisilozane (HMDS)) on the surface of patterned layer 46. In another example, surface treatment 100 may include a plasma treatment applied to convert at least a portion patterned layer 46 to oxide. In another example, surface treatment 100 may include an oxide deposited (e.g., CVD) onto the surface of patterned layer 46. Additionally, patterned layer 46 may be treated to provide selective adhesion characteristics as described in further detail in U.S. Ser. No. 09/905,718, U.S. Ser. No. 10/784,911, U.S. Ser. No. 11/560,266, U.S. Ser. No. 11/734,542, U.S. Ser. No. 12/105,704, and U.S. Ser. No. 12/364,979, which are all hereby incorporated by reference in their entirety.

Referring to FIGS. 23-24, patterned layer 46 positioned on substrate 12 may be used to imprint a second patterned layer 46b on a second substrate 12b using systems and methods described in relation to FIGS. 1 and 2 to form replica template 18a. Second patterned layer 46b of replica template 18a may include a second residual layer 48b and a plurality of features shown as protrusions 50b and recessions 52b. Protrusions 50b have a thickness t_{1B} and second residual layer 48b has a thickness t_{2B}. Second residual thickness t_{2B} may be less than residual layer thickness t₂ of patterned layer 46. Additionally, second patterned layer 46b may be substantially free of particles 60 and/or defects. It should be noted that formation of replica template 18a may include processes as described in U.S. Ser. No. 10/946,570, which is hereby incorporated by reference in its entirety.

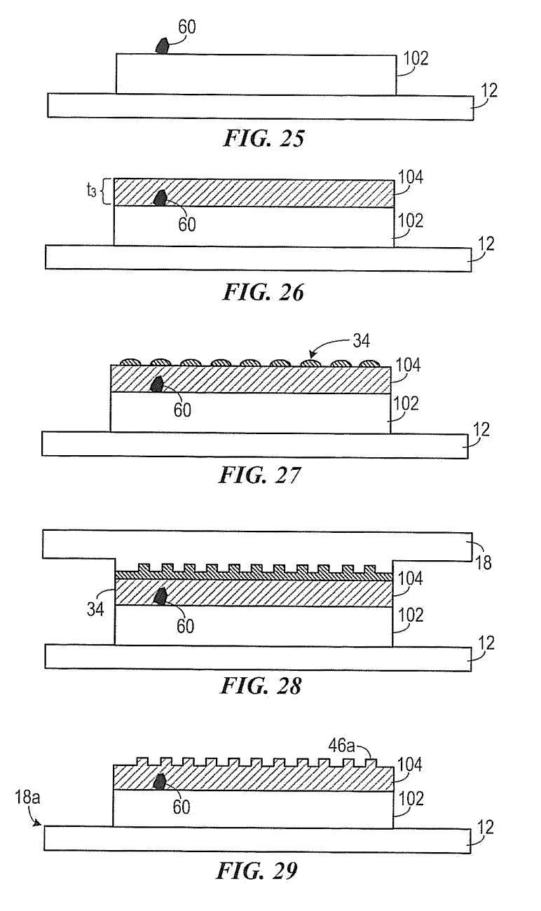

FIGS. 25-29 illustrate simplified side view of another exemplary method for formation of replica template 18a using master template 18 with minimal and/or no damage by particle 60.

Referring to FIG. 25, template 18 may include patterned substrate 12 coated with a soft layer 102. Soft layer 102 may conform about particle 60 during imprinting and minimize damage to template 18. Soft layer 102 may have a thickness t₃ between approximately 150 nm to 200 μm and may be substantially transparent to UV light. Additionally, soft layer 82 may have a Young's Modulus substantially less than fused silica. For example, modulus of glass is approximately 70 GPa. Soft layer 82 may have a modulus of approximately 0.50 GPa to 10 GPa.

Referring to FIG. 26, an oxide layer 104 may be optionally deposited on soft layer 102. Oxide layer 104 may be formed of materials including, but not limited to, silicon dioxide. Oxide layer 104 may be deposited by CVD, PECVD, sputter deposit, spin-on techniques, and/or the like.

Referring to FIG. 27, formable material 34 may be deposited on oxide layer 104 and/or soft layer 102 and patterned to form patterned layer 46a. Formable material 34 may be imprinted by template 18 forming patterned layer 46a using systems and processes described in relation to FIGS. 1 and 2.

Referring to FIG. 28, template 18 may be separated from patterned layer 46a forming replica template 18a. Particle 60 may remain within soft layer 102 and/or oxide layer 104 of replica template 18a. As such, damage by particle 60 to template 18 and/or template 18a may be limited. For example, as the modulus of soft layer 102 may be low, soft layer 102 may conform about particle 60 to cushion and/or limit damage to template 18 and/or template 18a during imprinting.

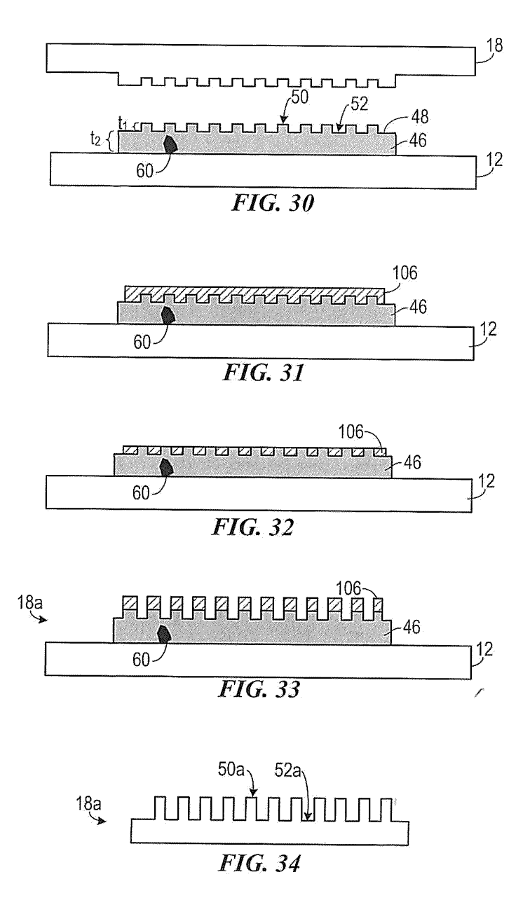

FIGS. 30-34 illustrate simplified side view of another exemplary method for formation of replica template 18a using master template 18 with minimal and/or no damage by particle 60.

Referring to FIG. 30, template 18 may imprint patterned layer 46 using systems and processes described in relation to FIGS. 1 and 2. Patterned layer 46 may include residual layer 48 and a plurality of features shown as protrusions 50a and recessions 52, with protrusions 50 having thickness t₁ and residual layer 48 having thickness t₂. Thickness t₂ of residual layer 48 may be increased to account for particle 60. For example, residual layer thickness t_{2A} may be greater than approximately 150 nm immersing particle 60.

Referring to FIG. 31, a selective layer 106 may be deposited on patterned layer 46. Selective layer 106 may be formed of materials including, but not limited to a silicon containing resist with a Si weight percent between 8 and 40%, a siloxane polymer, and/or the like.

Selective layer 106 may be deposited using processes such as spin-on process, imprint process, CVD process, and/or the like. Referring to FIG. 32, at least a portion of selective layer 90 may be etched to expose patterned layer 46. For example, at least a portion of selective layer 106 may be etched to expose protrusions 50 of patterned layer 46.

Referring to FIG. 33, patterned layer 46 may be selectively etched (e.g., resist etch) using selective layer 106 as a mask to form replica template 18a. Selectively etching using selective layer 106 as a mask to form replica template 18a eliminates the need for further pattern transfer steps.

Referring to FIGS. 33 and 34, in an alternate embodiment, patterned layer 46 may be selectively etched and undergo additional processing steps to form replica template 18a. For example, as illustrated in FIG. 34, features 50a and 52a may be etched into substrate 12 forming replica template 18a. Protrusions 50a may have a different dimension than protrusions 50 of patterned layer 46.

It should be noted that other imprint lithography techniques may be used to form replica template 18a using processes as described in relation to FIGS. 14-34. For example, additional imprint lithography techniques, such as those described in U.S. Ser. No. 10/789,319, U.S. Ser. No. 11/508,765, U.S. Ser. No. 11/560,928, and U.S. Ser. No. 11/611,287, all of which are hereby incorporated by reference in their entirety.

What is claimed is:

1. A method of forming a replica imprint lithography template with minimal damage from a plurality of particles positioned on a first substrate to a master imprint lithography template and the replica imprint lithography template, comprising:
forming, with the master imprint lithography template, a first patterned layer on the first substrate, the first patterned layer having a first residual layer having a first thickness and features with a first dimension and a first shape;
forming, with the first patterned layer, a second patterned layer on a second substrate, the second patterned layer having a second residual layer with a second thickness and features having a second dimension and a second shape;
wherein the second thickness is less than the first thickness and the second patterned layer is substantially free of particles.

2. The method of claim 1, wherein the first thickness of the residual layer is greater than dimensions of the particles such that the first residual layer immerses the particles positioned on the first substrate.

3. The method of claim 1, wherein forming the first patterned layer further comprises:
depositing and spreading a first formable material on the first substrate;
solidifying the first formable material; and
separating the master template from the first patterned layer.

4. The method of claim 3, further comprising applying a surface treatment to the first patterned layer.

5. The method of claim 4, wherein the surface treatment-facilitates spreading of the first formable material.

6. The method of claim 4, wherein the surface treatment facilitates release characteristics of the first patterned layer during separation of the master template from the first patterned layer.

7. The method of claim 1, wherein the second dimension and the second shape are substantially similar to the first dimension and the first shape.

8. The method of claim 1, further comprising removing at least one particle using a localized removal process.

9. The method of claim 8, wherein the localized removal process includes applying to the first substrate a resist layer, the resist layer substantially immersing the particle; and, removing the resist layer from the first substrate such that upon removal of the resist layer, the particle is removed from the first substrate.

10. The method of claim 8, wherein the localized removal process includes applying a suction force to the particle, magnitude of the suction force providing remove of the particle without damage to the first substrate.

11. The method of claim 8, wherein the localized removal process includes applying cryogenically cooled material to the particle.

12. The method of claim 11, wherein the particle subjected to cryogenically cooled material is removed by applying a vacuum force.

13. The method of claim 11, wherein the cryogenically cooled material diffuses the particle away from the first substrate.

14. The method of claim 8, wherein the localized removal process includes applying electrostatic forces to the particle.

15. The method of claim 1, wherein the master template includes a soft mask layer.

16. A method of forming a replica imprint lithography template with minimal damage from a plurality of particles positioned on a first substrate to a master imprint lithography template and the replica imprint lithography template, comprising:
positioning a soft layer on the first substrate, the soft layer conforming about at least one of the particles;
depositing and spreading formable material on the soft layer;
forming, with the master imprint lithography template, a first patterned layer on the first substrate, the first patterned layer having a first residual layer having a first thickness and features with a first dimension and a first shape;
separating the master imprint lithography template from the first patterned layer to form the replica imprint lithography template.

17. The method of claim 16, wherein the soft layer is substantially transparent to UV light.

18. The method of claim 16, wherein the Young's Modulus of the soft layer is less than the Young's Modulus of a material forming the master imprint lithography template.

19. The method of claim 16, further comprising, positioning an oxide layer on the soft layer.

20. A method of forming a replica imprint lithography template with minimal damage from a plurality of particles positioned on a first substrate to a master imprint lithography template and the replica imprint lithography template from a plurality of particles positioned on a first substrate, comprising:
forming, with the master imprint lithography template, a first patterned layer on the first substrate, the first patterned layer having a first residual layer having a first thickness and features including protrusions with a first dimension and a first shape, the first thickness greater than dimensions of at least one particle such that the first residual layer immerses the particle and is substantially uniform;
depositing a selective layer on the first patterned layer;
removing portions of the selective layer exposing a portion of each protrusion; and
transferring an inverse of the features into the first patterned layer;
transferring the inverse of the features into the first substrate forming the replica imprint lithography template.
